(19) United States
(12) Patent Application Publication
(10) Pub. No.: US 2023/0002256 A1
(43) Pub. Date: Jan. 5, 2023

(54) APPARATUS AND METHODS FOR REDUCING OR CONTROLLING SALT CONCENTRATIONS IN WATER

(71) Applicant: Jeffrey T. Clifton, Aledo, TX (US)

(72) Inventor: Jeffrey T. Clifton, Aledo, TX (US)

(21) Appl. No.: 16/788,294

(22) Filed: Feb. 11, 2020

Related U.S. Application Data
(60) Provisional application No. 62/804,043, filed on Feb. 11, 2019.

(51) Int. Cl. C02F 1/48

(52) U.S. Cl. CPC C02F 1/48; C02F 2301/046; C02F 2101/12

(57) ABSTRACT

An apparatus for treating water is disclosed. The apparatus comprises a feed tank for receiving water. The feed tank is coupled to a plurality of RF chambers. Each of the RF chambers comprises an inlet and an outlet. The outlet is coupled to a treated water effluent manifold. Further, each RF chamber is coupled to a vacuum manifold. Each RF chamber comprises a recirculation pipe to pump water back into the feed tank. The RF chamber comprises a RF system used for bombarding RF energy at predefined frequencies on the water passing in the chamber tubes in order to liberate chlorine isotope. Subsequently, the water is sent through the outlet to the treated water effluent manifold.

The present application claims the benefit of U.S. Provisional Application No. 62/804,043, filed Feb. 11, 2019; all of which is incorporated by reference herein.

### FIELD OF THE INVENTION

The present disclosure generally relates to an apparatus for treating water. More particularly, the present disclosure relates to an apparatus for treating water by liberating chlorine isotope using a RF system.

### DESCRIPTION OF THE RELATED ART.

It is known that presence of hazardous chemicals and soil composition in water effects when human beings or animals consume the water. As such, it is very important to treat water before it is consumed. Several methods and systems have been proposed in the past, which allow treating ground water or seawater.

Although the available systems are effective in treating water, it is difficult to remove chlorine from the water. Specifically, it is difficult to remove chlorine from seawater. An example of a method was disclosed in past that can be used to remove chlorine in the water i.e., in a U.S. Pat. No. 9,581,021. In U.S Pat. No. 9,581,021, a system for extraction of volatiles from bodies in a vacuum is disclosed. The volatile containing solid may be subsurface heated with microwave or RF energy subliming volatiles that are captured with a containment structure that directs the flow of the volatile through a cold trap for collecting and condensing the volatile. In one variation, a sample, or an entire body may be enveloped in a sealed container for extraction of volatiles that are then collected and condensed. In a further variation, a planetary surface area is covered and the perimeter sealed at the surface. The area is then heated from above to release volatiles that are then collected and condensed. To heat layers below the surface that contain high concentrations of volatiles, a hollow auger can gain access to the subsurface volatile and microwave or RF energy can be delivered down the hollow auger with a coax cable and vapor can escape through the hollow auger to a capture apparatus.

Although the disclosure presented above, and other similar disclosures that are known are useful in treating water, they have several problems. This is because; the disclosures of above type cannot break the ionic bond between the sodium and chlorine molecules, and carbon dioxide in the water. As a result, the water is not treated completely.

Other documents describing the closest subject matter provide for a number of more or less complicated features that fail to solve the problem in an efficient and economical way. None of these patents suggest the novel features of the present invention. Specifically, none of the disclosures in the art disclose an apparatus for treating water, which uses a RF system to liberate chlorine isotope.

Therefore, there is a need in the art for an apparatus for treating water, which uses a RF system to liberate chlorine isotope.

### SUMMARY

It is one of the main objects of the present invention to provide an apparatus for treating water and that avoids the drawbacks of the prior art.

It is one object of the present invention to provide an apparatus for treating water. The apparatus comprises a feed tank for receiving water. The feed tank is coupled to a plurality of RF chambers. Each of the RF chambers comprises an inlet and an outlet. The outlet is coupled to a treated water effluent manifold. Further, each RF chamber is coupled to a vacuum manifold. Each RF chamber comprises a recirculation pipe to pump water back into the feed tank. The RF chamber comprises a RF system used for bombarding RF energy at predefined frequencies on the water passing in the chamber tubes in order to liberate chlorine isotope. Subsequently, the water is sent through the outlet to the treated water effluent manifold.

It is another object of the present invention to use RF energy at particular frequencies to liberate chlorine isotope and to collect the chlorine isotope at a chlorine gas discharge system.

It is another object of the present invention to focus the RF energy towards the salt solution i.e., the water passing through the chamber tubes to capture remaining RF energy by a faraday cage and to direct the captured RF energy to a power amplifier to resupply the RF energy.

Further objects of the invention will be brought out in the following part of the specification, wherein detailed description is for the purpose of fully disclosing the invention without placing limitations thereon.

### BRIEF DESCRIPTION OF THE DRAWINGS

With the above and other related objects in view, the invention consists in the details of construction and combination of parts as will be more fully understood from the following description, when read in conjunction with the accompanying drawings in which:

FIG. 1 illustrates a schematic diagram of an apparatus 100 comprising a feed tank 100 and a plurality of RF chambers 120 for treating water, in accordance with one embodiment of the present disclosure.

FIG. 2 illustrates a schematic diagram of the feed tank 110 coupled to the RF chamber 120, in accordance with one embodiment of the present disclosure.

FIG. 3 illustrates a RF system 200 used for bombarding RF energy at water, in accordance with one embodiment of the present disclosure.

FIG. 4 illustrates a method 300 of treating water, in accordance with one embodiment of the present disclosure.

FIG. 5 illustrates an electrical schematic for a circuit for performing the presently disclosed method 300 of treating water, in accordance with one embodiment of the present disclosure.

### DESCRIPTION OF THE EMBODIMENTS OF THE INVENTION

The following detailed description is intended to provide example implementations to one of ordinary skill in the art, and is not intended to limit the invention to the explicit disclosure, as one or ordinary skill in the art will understand that variations can be substituted that are within the scope of the invention as described.

The present disclosure discloses an apparatus for treating water. The apparatus comprises a feed tank for receiving water. The feed tank is coupled to a plurality of RF chambers. Each of the RF chambers comprises an inlet and an outlet. The outlet is coupled to a treated water effluent manifold. Further, each RF chamber is coupled to a vacuum manifold. Each RF chamber comprises a recirculation pipe to pump water back into the feed tank. The RF chamber comprises a RF system used for bombarding RF energy at predefined frequencies on the water passing in the chamber tubes in order to liberate chlorine isotope. Subsequently, the water is sent through the outlet to the treated water effluent manifold.

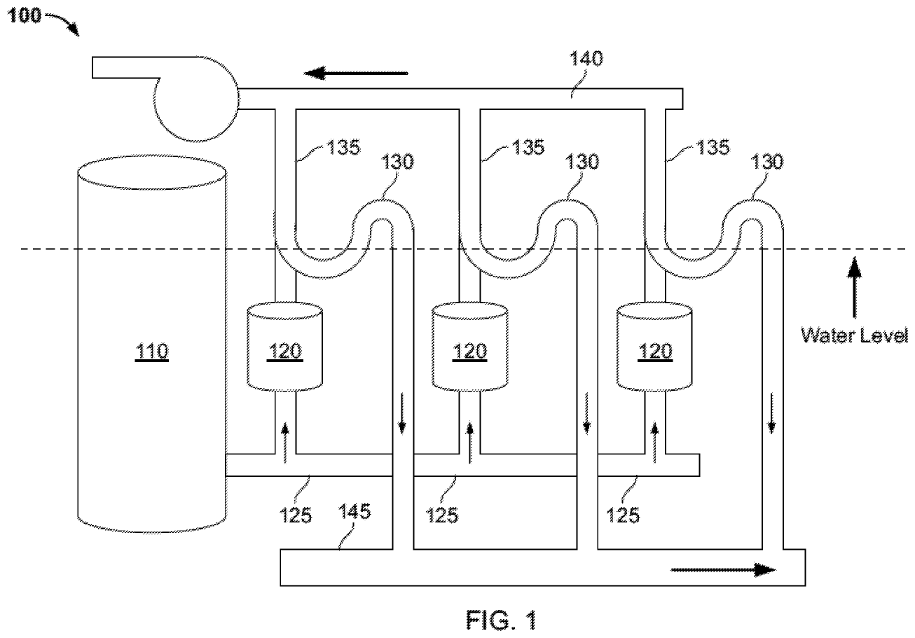

Various features and embodiments of an apparatus for treating water are explained in conjunction with the description of FIGS. 1-4.

Referring to FIG. 1, a schematic diagram of an apparatus 100 for treating water is shown, in accordance with one embodiment of the present disclosure. The apparatus 100 comprises a feed tank 110. The feed tank 110 may be used to store salt water. The size of the feed tank 110 may be selected depending on the effluent volume of the system. In preferred embodiment, nominal effluent volume will be 1500/gpm/5600/lpm, calculating that we will need a nominal saltwater feed tank capable of holding 8000 gallons of water.

The salt water may be received into the feed tank 110 from a variety of sources. It should be understood that if the source of the water produced water, the water would be passed through an oil/water separator, then through a 200-micron filtration system. Further, if the feed water is from a natural source such as an open sea water, lake, etc., then the water will pass through a ¼ inch strainer to strain out large debris, and then through a 20-micron filtration system. At the feed tank, carbon dioxide gas is added in the water for preprocessing. The water is preprocessed to lower the pH of the water and to entrain the carbon dioxide for use later in the process.

Further, the apparatus 100 may comprise a plurality of RF chambers 120, each having an inlet 125 for receiving salt water into the RF chamber 120. Further, each of the RF chambers 120 may comprise an outlet 130. Further, each of the RF chambers 120 may comprise a vacuum tube 135 coupled to a vacuum manifold 140. The outlet 130 may be coupled to a treated water effluent manifold 145.

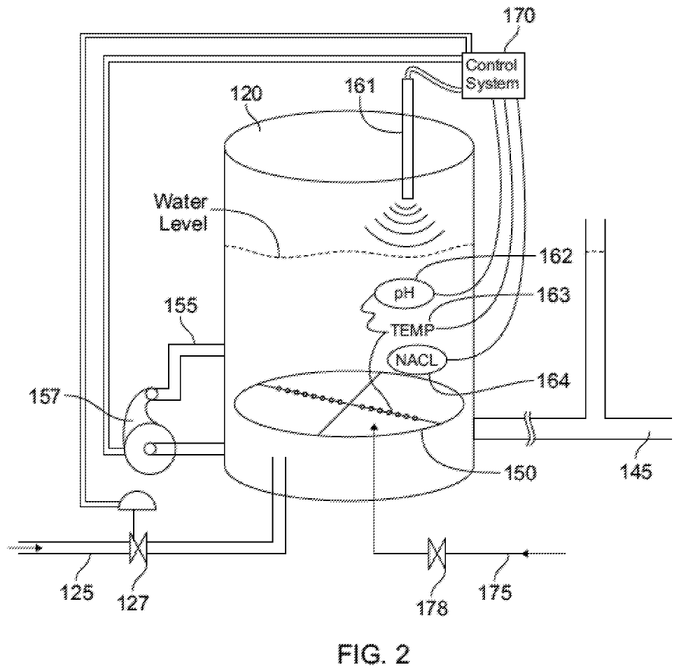

Referring to FIG. 2, the RF chamber 120 is explained. At the inlet 125, an inlet valve 127 may be provided to control the flow of water into the RF chamber 120. The RF chamber 120 further comprises chamber tubes (not shown) to receive the salt water inside the RF chamber 120. The chamber tubes are provided in a coiled manner such that the salt water is raised to top of the RF chamber 120.

In one implementation, the RF chamber 120 is provided with a recirculation pipe 155 to pump water back into the feed tank 110. In one example, a pump 157 may be used to pump the water from the RF chamber 120 to the feed tank 110.

The RF chamber 120 may be provided with plurality of sensors such as a water level i.e., ultrasonic level indicator 161, a pH/carbon dioxide indicator 162, a temperature sensor 163, a conductivity (sodium) indicator 164 and a salt concentration indicator (not shown). Each of ultrasonic level indicator 161, the pH/carbon dioxide indicator 162, the temperature sensor 163, the conductivity (sodium) indicator 164 and the salt concentration indicator may be coupled to a control system 170 provided at the RF chamber 120. It should be understood that the ultrasonic level indicator 161 is used to determine water level in the RF chamber 120. The pH/carbon dioxide indicator 162 is used to determine the pH content/level in the water in RF chamber 120. Further, the temperature sensor 163 is used to determine the temperature of water in the RF chamber 120. The conductivity (sodium) indicator 164 is used to determine sodium content in water in the RF chamber 120. The salt concentration indicator is used to determine salt concentration in water.

Further, the RF chamber 120 comprises a chemical/gas injection manifold 175 for storing chemicals. In one example, the chemical/gas injection manifold 175 may be used to store gases/chemicals such as carbon dioxide, carbon powder, or even hydrogen gas. The chemical/gas injection manifold 175 coupled to the RF chamber 120 via an injector tube (not shown). The injector tube may be provided with a valve 178 to control the flow of the chemicals injected into the RF chamber 120 or the chamber tubes.

It should be understood that the control system 170 might indicate a computer used to operate the RF chamber. In one implementation, the control system 170 is electrically coupled to the inlet valve 127, and the pump 157.

The recirculation pipe 155 may be provided in proximity to the feed tank 110 to return excess water in the RF chamber 120 to the feed tank 110. The recirculation pipe 155 may be operated with the help of the pump 157 to turn the water over one time every 10 minutes. The control system 170 may operate the inlet valve 127 to admit water into the feed tank 110. From the feed tank 110, water will travel to the salt water feed manifold and then water is made to rise into the chamber tube. The level of the salt water in the chamber tube will be equal to water level in the feed tank 110. This is based on Pascal's Principle for hydrostatic pressure. Using Pascal's Principle, automated pumps, valves, and associated controls are not required.

The RF chamber 120 further comprises a RF system 200. The RF system 200 may comprise a frequency Oscillator/Generator 205, a Pre-Amplifier 210, a power Amplifier 215, a RF Delivery system 220 and a Faraday Cage/Receiver 225. It should be understood that the RF delivery system 220 and the Faraday Cage/Receiver 225 are placed in such a way that the chamber tube passes between them. It should be understood that the RF system 200 might be operated with the help of the control system 170.

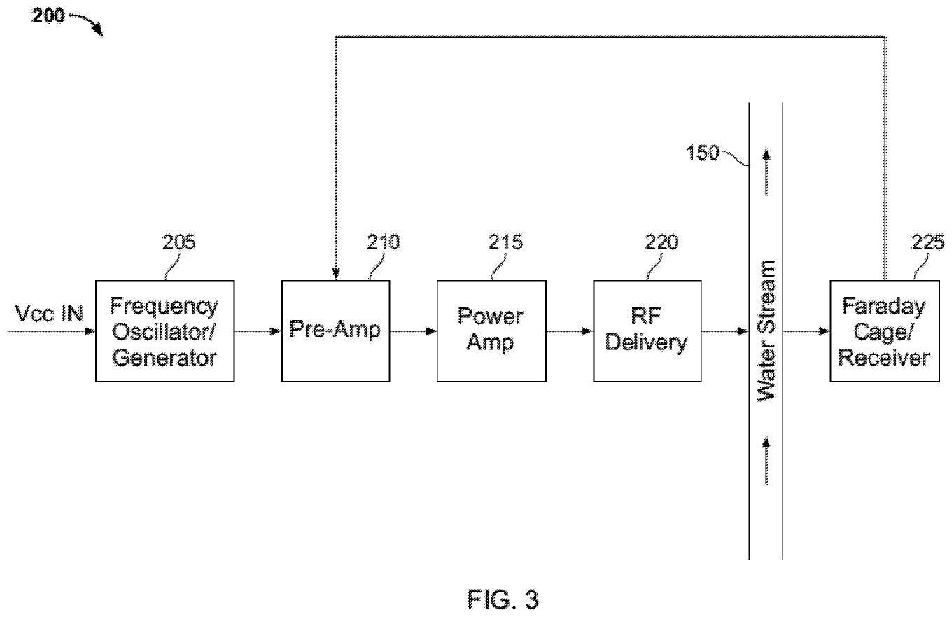

In operation, when the water enters into the RF chamber 120, the RF system 200 is employed to bombard RF energy on the water passing in the chamber tube as shown in FIG. 3. It should be understood that the water is bombarded with RF energy at predefined frequencies. In preferred embodiment, the predefined frequencies may include, but not limited to, 8.156 MHz and 9.790 MHz. The target isotope will determine the specific frequency used for the process desired.

When the water is subjected to the RF bombardment, the atom or isotope targeted will begin to resonate. When the isotope resonates, it will break apart from its ionic bond, into its non-bonded state. When a chlorine isotope is liberated from the chlorine-sodium molecule, a suitable substitute has to be added to prevent a violent sodium-water reaction. Depending on geographic location or region of in which the apparatus is used, different compounds can be added to the saltwater feed tank to accomplish this goal, such as carbon dioxide, carbon powder, or even hydrogen gas. If carbon powder or carbon dioxide is added, the resulting compound will be sodium carbonate. If hydrogen is added, then the resulting compound would be sodium hydroxide.

It should be understood that the RF energy is focused towards the salt solution i.e., the water passing through the chamber tubes 150, such that any remaining RF energy will be captured by the faraday cage 225 and will be directed to an attenuator which will feed it back into power amplifier 210.

After the RF energy breaks the ionic bond between the sodium and chlorine molecules, carbon dioxide (introduced in the salt water feed tank) will now bond ionically with the sodium. As a result of the RF energy bombardment, the chlorine in its excited state will not rebind with sodium. Since the upper third of the RF chamber 120 is in a vacuum, the newly liberated chlorine will come out of the solution into the vacuum area and be drawn up into the vacuum manifold 140. Once in the vacuum manifold 140, the chlorine gas will be directed to the inlet of a chlorine compressor (not shown), where it will be stored. In other words, top 30% of the RF chamber 120 is under a vacuum of mercury. This atmospheric pressure change will reduce the surface tension of the water, which will make it easier to release chlorine. Operating the upper ⅓ under a vacuum allows assisting the RF system 200 in liberating the chlorine isotope and when the chlorine isotope is liberated, it will be routed through the chlorine gas discharge system and collected.

Further, after the RF energy breaks the ionic bond between the sodium and chlorine molecules, carbon dioxide (introduced in the salt water feed tank) will now bond ionically with the sodium. The solution, which is now clear of chlorine, will go into a syphon loop. The function of the loop is to allow the effluent stream a path while not allowing a leak into the vacuum system. Once the effluent has passed through the syphon loop, it will be directed toward the treated water manifold 145 where it will be stored for further (conventional purification steps) treatment.

As explained above, the RF chamber 120 comprises the outlet 130, which is provided in a U-shape. The outlet 130 relies on the Clausius-Clapeyron Equation to estimate and ultimately control vapor pressure of the water. As known, Clausius-Clapeyron is a mathematical model for pressure increase, as a function of temperature increases. The vaporization curves of most liquids have a similar shape; vapor pressure increase as temperature increases. The Clausius-Clapeyron Equation provides an estimate of vapor pressure at any temperature if vapor pressure is known at one temperature, and if the enthalpy of vaporization (thermodynamic quantity equivalent to the total heat content of a system) is known. As such, the Clausius-Clapeyron Equation may be provided as below:

P=Aexp(−DHᵥₐₚ/RT)

### Where: Pressure=P

Enthalpy of vaporization=DHᵥₐₚ
Temperature=T
R(=8.3145 Jmol⁻¹ K⁻¹)
A are the gas constant and unknown constant.

If P₁and P₂ are the pressures at two temperatures T₁ and T₂ the equation has the form:

$$ln ( \frac{{P}_{1}}{{P}_{2}} ) = \frac{{DH}_{vap}}{R} ( \frac{1}{{T}_{2}} - \frac{1}{{T}_{1}} )$$

Based on the above, once the water passes through the series of U-shaped outlets 130, it is dumped into the treated water effluent manifold 145 and then onto a treated water storage tank (not shown). Once in the treated water storage tank, the water will be routed through a filtration system (not shown) to remove sodium-carbonate or sodium-hydroxide. Once collected, the water will be sent to the storage tank for disinfecting.

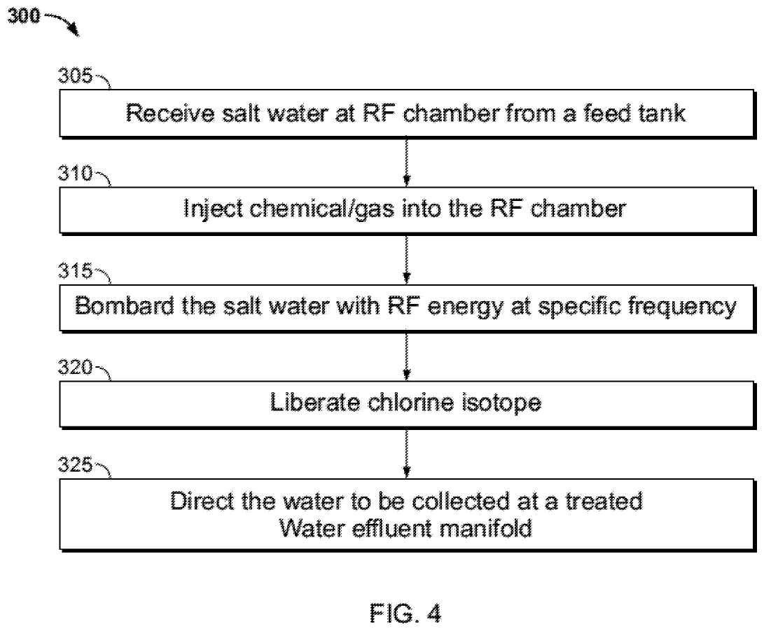

Referring to FIG. 4, a method 300 of treating water is shown in accordance with one embodiment of the present disclosure. The order in which the method 300 is described and is not intended to be construed as a limitation, and any number of the described method blocks can be combined in any order to implement the method 300 or alternate methods. Additionally, individual blocks may be deleted from the method 300 without departing from the scope of the disclosure described herein.

At step 305, water is received at RF chamber 120 from the feed tank 110.

At step 310, chemical or gas is injected into the RF chamber 120 or the chamber tube.

At step 315, RF energy is bombarded at the water flowing through the chamber tube with the help of RF system 200. In an alternate embodiment, the RF energy may be bombarded first and then the chemical/gas is injected to prevent a violent sodium-water reaction.

At step 320, chlorine isotope is liberated and collected at the chlorine gas discharge system.

At step 325, the water is directed to be collected at the water effluent manifold 145 through the outlet 130.

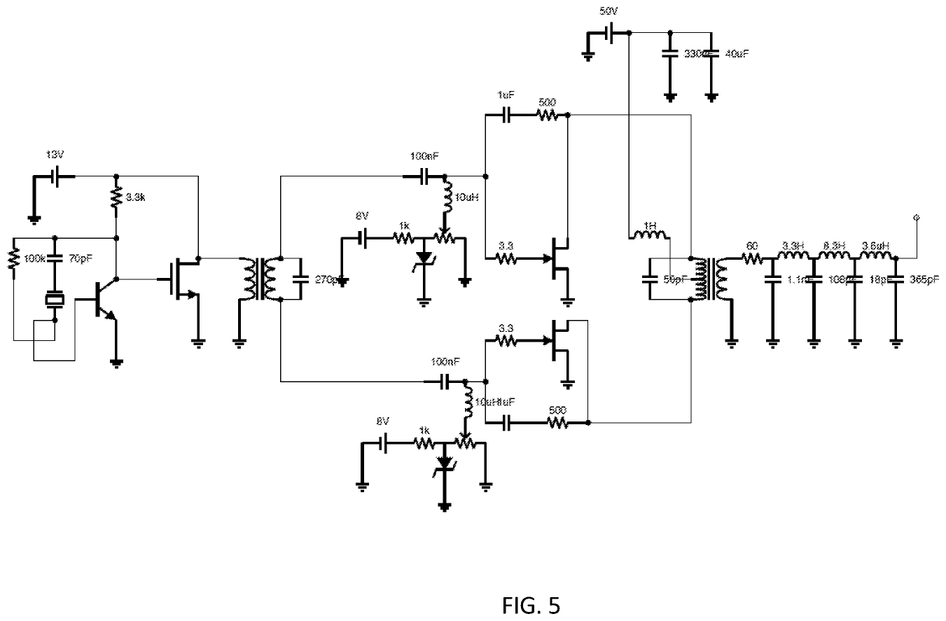

FIG. 5 illustrates an electrical schematic for a circuit for performing the presently disclosed method 300 of treating water, in accordance with one embodiment of the present disclosure.

It is evident from the above disclosure that the salt water is treated by RF energy at a particular frequency to liberate chlorine isotope. Further, the chlorine isotope liberated is routed to and collected at the chlorine gas discharge system.

Further, as the RF energy is focused towards the salt solution i.e., the water passing through the chamber tubes to capture remaining RF energy by the faraday cage. Further, the captured RF energy is directed to the power amplifier to resupply the RF energy.

### Reference Numerals

Apparatus 100

Feed Tank 110

RF Chambers 120

Inlet 125

Inlet Valve 127

Outlet 130

Vacuum Tube 135

Vacuum Manifold 140

Treated Water Effluent Manifold 145

Recirculation Pipe 155

Pump 157

Ultrasonic Level Indicator 161

pH/Carbon Dioxide Indicator 162

Temperature Sensor 163

Conductivity (Sodium) Indicator 164

Control System 170

Chemical/Gas Injection Manifold 175

Valve 178

RF System 200

Frequency Oscillator 205

Pre-Amplifier 210

Power Amplifier 215

RF Delivery System 220

Faraday Cage/Receiver 225

Method 300

The foregoing description conveys the best understanding of the objectives and advantages of the present invention. Different embodiments may be made of the inventive concept of this invention. It is to be understood that all matter disclosed herein is to be interpreted merely as illustrative, and not in a limiting sense.

1. An apparatus for treating water comprising:
a feed tank for receiving water, said tank is coupled to a plurality of RF chambers, said RF chambers include an inlet and an outlet, said outlet is coupled to a treated water effluent manifold, wherein each RF chamber is coupled to a vacuum manifold and include a recirculation pipe to pump water back into the feed tank, and wherein each RF chamber includes a RF system for bombarding RF energy at predefined frequencies on the water passing in chamber tubes in order to liberate chlorine isotope, the water being sent through said outlet to said treated water effluent manifold;
using RF energy at particular frequencies to liberate chlorine isotope and to collect the chlorine isotope at a chlorine gas discharge system;
focusing the RF energy toward the salt solution, i.e., the water passing through said chamber tubes to capture remaining RF energy by a faraday cage and to direct the captured RF energy to a power amplifier to resupply the RF energy.
